(19) United States
(12) Patent Application Publication
(10) Pub. No.: US 2002/0087570 A1
(43) Pub. Date: Jul. 4, 2002

(54) Space and time information system and method

(76) Inventors: Geoffrey M. Jacquez, Ann Arbor, MI (US); Andrew Kaufmann, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/004,479

(22) Filed: Nov. 1, 2001

Related U.S. Application Data
(60) Provisional application No. 60/245,270, filed on Nov. 2, 2000.

(51) Int. Cl. G06F 7/00

(52) U.S. Cl. 707/100; 707/1

(57) ABSTRACT

A programming tool and a method of operating the programming tool models an object that moves through time using an object oriented data model. The data model includes a data parameter and a time parameter. An instance of the object oriented data model has a data value associated with the data parameter and a time value associated with the time parameter. The data value is associated with the instance of the item at the time value. A chain of instances of the object oriented data model represents the object as the object moves and changes through time. The programming tool includes a plurality of methods adapted to operate on the chain of instances of the object oriented data model.

### FIELD OF THE INVENTION

The present invention relates generally to object oriented programming and more particularly to a system and method for space and time information.

### BACKGROUND OF THE INVENTION

Existing data modeling systems adequately organize spatial information, but they cannot support temporal data queries. One such system is a Geographic Information System (GIS) package. Previous GIS classified objects for queries in two dimensions—“what” and “where”—storing temporal information as an attribute of the spatial object. Thus, programs cannot index data by time, preventing rapid data queries on temporal parameters. In this approach, change over time can be described qualitatively in a series of maps or snapshots, but not quantitatively. As most data has a time dimension, current GIS packages only allow visualization of half of the picture.

The lack of spatio-temporal capabilities in GIS is a particular problem for public health applications. Because of the spatial component of disease exposure and spread, GIS provide powerful tools for public health analysis. However, because diseases spread over space and through time, realistic analyses are hindered by existing technology. For instance, time lags between exposure and symptoms of disease are a common occurrence. Yet, time lags cannot be incorporated into current GIS models. Also, people are mobile, so the location where an individual is exposed may not be the same place where the disease is manifested or transmitted.

The present invention is aimed at one or more of the problems identified above.

### SUMMARY OF THE INVENTION AND ADVANTAGES

In one aspect of the present invention, an object oriented data model for modeling an item using a computer is provided. The object oriented data model includes a data parameter and a time parameter. An instance of the object oriented data model has a data value associated with the data parameter and a time value associated with the time parameter. The data value being associated with the instance of the item at the time value.

In another aspect of the present invention, a programming tool for modeling an object that moves through time, is provided. The programming tool includes an object oriented data model which includes a data parameter and a time parameter. An instance of the object oriented data model has a data value associated with the data parameter and a time value associated with the time parameter. The data value is associated with the instance of the item at the time value. A chain of instances of the object oriented data model represents the object as the object moves through time. The programming tool includes a plurality of methods adapted to operate on the chain of instances of the object oriented data model.

In a further aspect of the present invention, a computer based method of modeling items using object oriented data models with space and time data is provided. The method includes the step of representing an item in a first instance of the data model. The data model includes at least one data parameter. A value of the data parameter within the first instance of the data model is associated in time with the first instance. The method includes the step of representing the item in a second instance of the data model. The value of the data parameter tracks a spatial-time event of the item in the second instance of the data model.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of an object oriented data model for modeling an item using a computer, according to an embodiment of the present invention;

FIG. 2 is a block diagram of an application programming tool utilizing the object oriented data model of FIG. 1;

FIG. 3 is a flow diagram of a computer based method for modeling items using object oriented data models with space and time data;

FIG. 4 is is a block diagram illustrating the relationships of the elements of STroodle and a sample application, STIS-Influenza;

FIG. 5 is a block diagram of a chain of items utilizing the object oriented data model of FIG. 1;

FIG. 6 is a block diagram of a chain of items modeling a point;

FIG. 7 is a block diagram illustrating the relationship between an implementation of the object oriented data model and a geographic information system, according to an embodiment of the present invention; and

FIG. 8 is a diagrammatic illustration of an unfiltered rectangular query;

FIG. 9 is a diagrammatic illustration of a targeted query using a filter;

### DETAILED DESCRIPTION OF THE PREFERRED EMBODIMENT

I. Overview

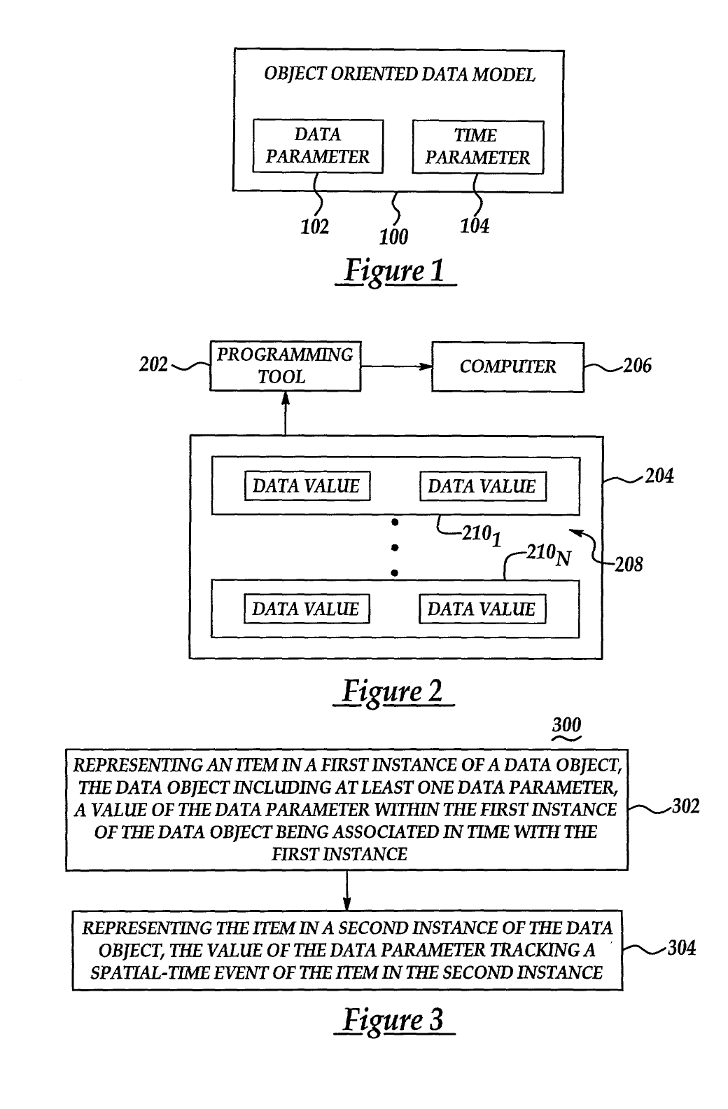

With reference to the drawings and in operation, the present invention provides a space and time information system and method. With specific reference to FIG. 1, the system and method utilize an object oriented data model 100 for modeling an item. In one embodiment, the object oriented data model 100 includes a data parameter 102 and a time parameter 104.

In operation, instances of the object oriented data model 100 have a data value associated with the data parameter 102 and a time value associated with the time parameter 104. The data value is associated with the instance of the item at the time value.

In one embodiment, the time value is a discrete value. Thus, the value of the data parameter 102 represents the value of the data parameter 102 at the time value. In another embodiment, the time value is a range of time with a start value and an end value. Thus, the value of the data parameter 102 represents the value of the data parameter 102 over the range of time.

The object oriented data model may be used to model any type of item such as a biological organism, an infectious disease, a business process, or a geometric construct, e.g., points, lines, multi-lines, polygons, or circles.

The most basic data model can by represented by: (x, y, t a₁, a₂, . . . , a_{N}), where x and y represent geographical coordinates, e.g., latitude and longitude, t is a time point or interval, and a₁, a₂, . . . , a_{N} are attributes observed at the space-time location defined by x, y, t. These attributes may include an object identifier, e.g., a person, their weight, height, disease state, other medical information, etc. . . . However, it should be noted that the data model may also be applied to non-biological systems, including business inventory, e.g., product location and status, management data, e.g., asset distribution, and other business applications. In addition, the data model includes remotely sensed imagery, such as satellites and air-borne platforms. Here x and y correspond to a pixel in an image, t is the time the image was observed, and the attributes are the spectral bands, e.g., corresponding to parts of the electromagnetic spectrum, such as green light, infrared and so on, captures by the sensor.

With specific reference to FIG. 2, the present invention may be embodied in a programming tool 202 for modeling an object or item 204 that moves through time. Preferably, the programming tool 202 is implemented on a computer 206, such as a personal computer. The programming tool 202 models the object 204 using a chain 208 of instances 210₁-210_{N} of the object oriented data model 100. Each instance 210₁-210_{N} includes an associated data parameter with a data value and an associated time parameter with a time value. The data value is associated with the respective instance 210₁-210_{N} of the item 204 at the time value.

The chain 208 of instances 210₁-210_{N} of the object oriented data model 100 represents the object 204 as the object 204 moves through time.

As discussed below, a plurality of methods are adapted to operate on the chain of instances 210₁-210_{N} of the object oriented data model 100.

In one embodiment, the time value in each instance 210₁-210_{N} of the object oriented data model 100 is a discrete value. In another embodiment, the time value is a range of time with a start value and an end value.

The item 204 represented by the chain 208 may be representative of both living and non-living things, e.g., biological organisms, geometric constructs, and infectious diseases, as well as items of human commerce as occurs in sales, marketing and business. Examples of geometric constructs includes points, lines, multi-lines, polygons and circles.

As described below, in a first embodiment the plurality of methods includes spatial queries. For example, spatial queries may include one or more of the following: a length query, area query, position query, point path query, nearest neighbor query, adjacency query, border polygons query, border length query, distance query, overlap query, or polygon containment query.

As described below, in a second embodiment the plurality of methods includes network queries. For example, network queries may include one or more of the following: a distance query, adjacency query, nearest neighbor query, and neighbors by node query.

As described below, in a third embodiment the plurality of methods includes spatio-temporal object queries. For example, spatio-temporal object queries may include one or more of the following: an object chain and subject query, a threshold distance query, a minimum distance query, a polygon containment interval query, a distance over time query, a collision query, a close call query, and a distance between objects over time query.

As described below, in a fourth embodiment, the plurality of methods includes epidemiological queries. Epidemiological queries may include event/diagnosis queries.

For example, event/diagnosis queries may include one or more of the following: a define event query, a find first event query, a find events in interval query, a nearest events to focus event query, a nearest event to certain time query, a waiting time between pairs of events query, and a waiting time between all events query. For example, epidemiological queries may also include one or more of the following: an exposure time query, a find exposed query, and an epidemic curve query.

With specific reference to FIG. 3, in one embodiment, the present invention is embodied in a computer based method 300 for modeling items using an object oriented data model with space and time data. The method 300 includes the steps of representing an item in a first instance of the data model 100 (see block 302). The data model 100, as described above, includes at least one data parameter. A value of the data parameter within the first instance of the data model 100 is associated in time with the first instance. In a second block 304, the item is represented in a second instance of the data model 100. The value of the data parameter tracks a spatio-time event of the item in the second instance of the data model 100.

II. The STroodle Implementation

A. Overview

In one embodiment, the present invention is embodied in a programming tool, called “STroodle” for building spatio-temporal analysis applications. While on one level. STroodle extends temporal analysis methods to Geographic Information Systems (GIS), it also opens up new possibilities and applications. Additionally, STroodle was developed especially for public health applications. However, STroodle may be applied to any data that has time considerations. Preferably, the STroodle library can be used as ActiveX Controls or C++ applications.

In implementation, STroodle adds temporal and spatio-temporal methods to an existing GIS programming library. Objects that move through time and space are treated in STroodle as a chain of spatial objects; each object chain consists of one subobject at each time point. Spatio-temporal methods in STroodle include spatial queries, temporal queries, spatio-temporal queries, and epidemiological queries. Examples of each are listed below.

Spatial Queries: Length, Area, Position, Point path, Nearest neighbor, Adjacency, Border polygons, Border length, Distance, Overlap, Polygon containment

Network queries: Distance, Adjacency, Nearest neighbor, Neighbors by node,

Temporal Queries: Lifespan, View time slice, Interval containment , Interval overlap, Lifespan union, Lifespan intersection, Attributes at time

Spatio-temporal Object Queries: Object chain and subobject, Threshold distance, Minimum distance, Polygon containment intervals, Distance over time, Collisions, Close calls, Distance between objects over time

Epidemiological Queries: Exposure time, Find exposed, Epidemic curve

Event/diagnosis queries: define event, find first event, find events in interval, nearest events to focus event, nearest event to certain time, waiting time between pairs of events, waiting time and distances between pairs of events, between all events

The STroodle library was written in C++. STroodle functions can be called through an ActiveX Control or as a part of a C++ application using Microsoft Virtual C++ or Metrowerks CodeWarrior. The ActiveX control can be used on Windows 95, 98, and NT operating systems.

STIS-influenza (see below) was developed using the ActiveX control and runs on Windows machines. The graphics for STIS-Influenza were developed using OpenGL, and the OpenGL dlls are supplied with the installation disk. STIS-Influenza requires a screen resolution of 1024×768 and a Pentium chip with a minimum speed of 120 MHz. The rendering speed will be faster for computers with higher chip speeds and OpenGL-based graphics cards. STIS-Influenza and the ActiveX control are Windows-based, and STroodle is also compatible with CodeWarrior on MacOS.

STroodle builds on the existing classes and functions of BioMedware's ToodlePip spatial library. For technical information regarding ToodlePip, refer to Technical Appendix B, a listing of the object classes with short descriptions of the functions.

For easier differentiation of code and description, the following style conventions will be used:

| Typeface | Meaning |
|---|---|
| regular | explanatory text |
| underlined bold | words defined in the |
| | glossary, emphasized |
| | when first encountered |
| | only |
| sans serif | computer code |

The STroodle programming library provides critical new tools for spatio-temporal analysis. Stroodle supports spatio-temporal and epidemiological queries and applies to any data with a temporal dimension. It can be used as written or it can be further customized to fit specialized applications. STroodle was written in C++, though it can also be used as an ActiveX control.

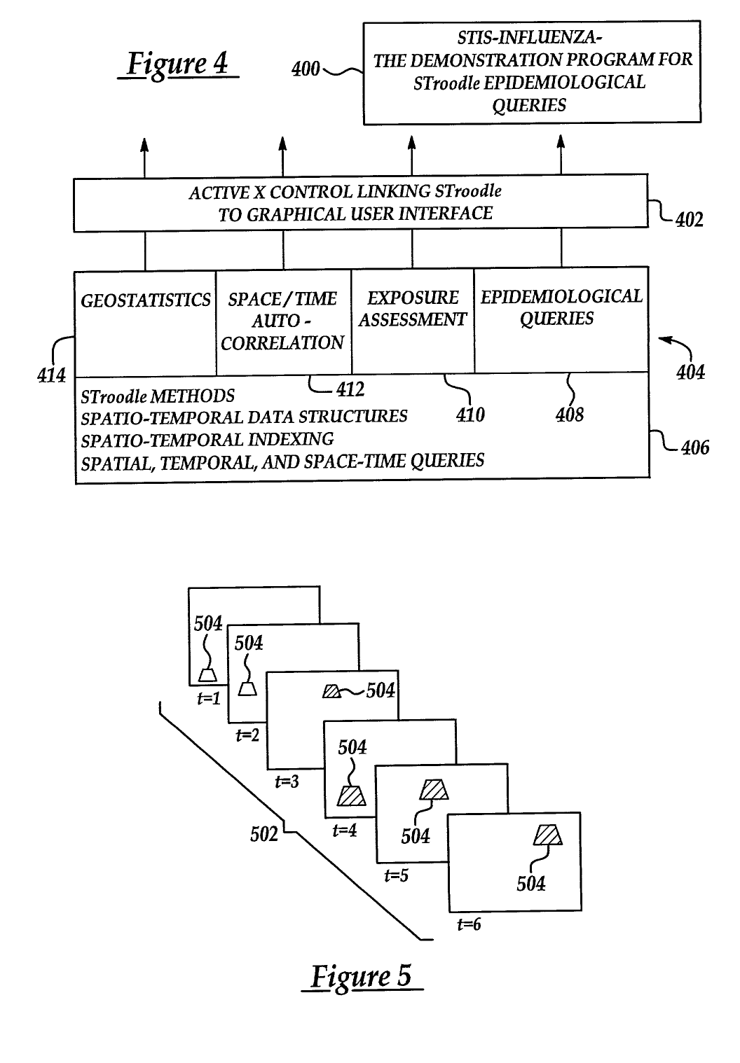

With reference to FIG. 4, a sample application, STIS-Influenza 400, provides a way to visualize some STroodle queries using the ActiveX control 402 and an example data set on the spread of influenza within a hospital (see below).

STroodle 404 contains general methods 406 and methods specific to certain fields of interest, or knowledge domains, such as epidemiology 408, exposure assessment 410, environmental sciences 412, and geostatistics 414. The STIS-Influenza application 400 will be described in depth below.

With reference to FIG. 5, STroodle 404 represents items or objects moving through time and space as chains 502 of subobjects 504. These object chains 502 can describe people, raccoons, mosquitoes, trees, or even structures. Object chains 502 can have time-dependent attributes such as weight, height, disease status, size, etc. These attributes, however, are fixed in the duration of a subobject. While observations on chains occur at a finite number of time points or time intervals, these observations do not have to happen at the same time for all items or objects under scrutiny.

STroodle 404 can handle observations on objects in two ways-as snapshots in time or as continuous objects. For snapshot-type methods, STroodle 404 can model object chains as a linked list of time point data, with no projections of movement between observations, as shown in FIG. 5. This method restricts analyses of the object to the time points or time intervals recorded. Essentially, the object will disappear between records. The object represented in the chain 502 is a geometric construct 504. The chain stores data at times t=1 to t=5 representing the constructs 504 size, color and position.

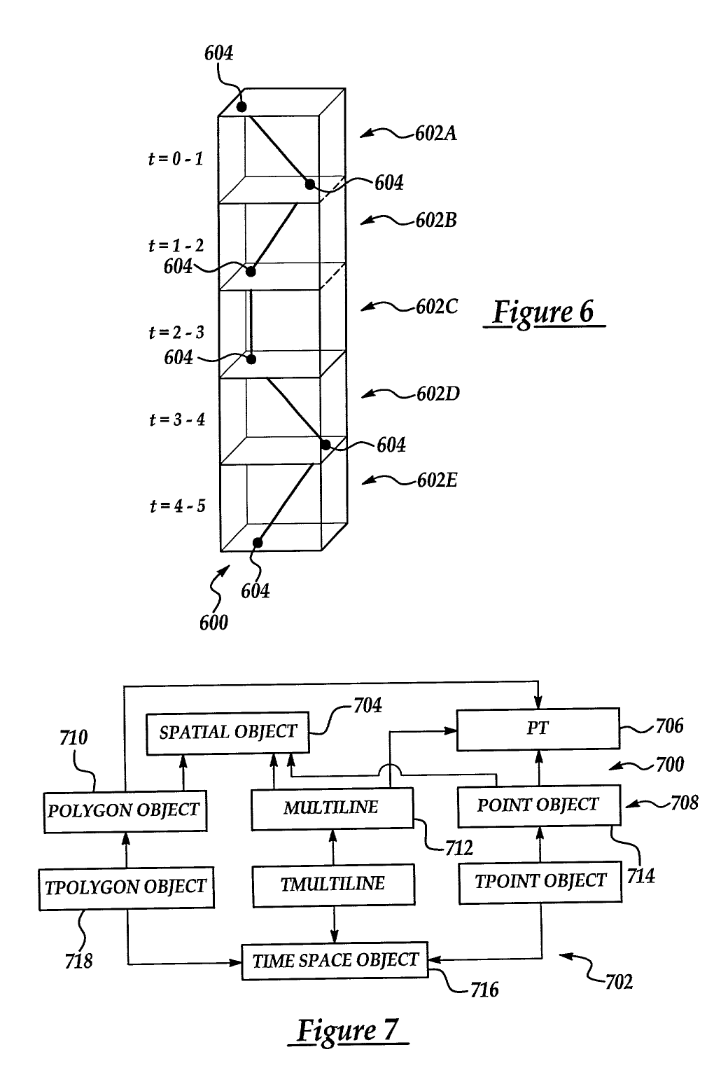

Alternatively, STroodle 404 can model continuous objects, as shown in FIG. 6 This is achieved by creating subobjects with start times equal to the end time of the previous subobject. In one embodiment, movement within an observation interval occurs linearly at a constant speed, but movement may also be modeled between observation intervals in a nonlinear manner. This method can also be used to simulate continuity between discrete observations.

In FIG. 6, a chain 600 of subobjects or instances(represented by cubes) 602A, 602B, 602C, 602D, 602E represent a point 604 as it moves in time and space. The table below lists the point's 604 coordinates at the beginning of each observation interval. Each cube 602A 602B, 602C, 602D, 602E represents an observation interval, and the object chain 600 is the stack of cubes 602A, 602B, 602C, 602D, 602E. To achieve continuity, each new observation begins at the end of the previous interval. Modeled in this way, the point 604 exists between observation start times (e.g. t=1.5). In this example, only linear movement can occur within an observation period.

| x | y | t |
|---|---|---|
| 2 | 2 | 0 |
| 5 | 4 | 1 |
| 2 | 4 | 2 |
| 2 | 5 | 3 |
| 6 | 5 | 4 |
| 3 | 2 | 5 |

Object chains have certain features. They are single strands that do not break spatially, do not split to create two subobjects at one time point, nor do they join. For example, pregnancy may be handled by having two entities occupy the same location from conception until birth, but at birth their paths diverge. Cellular division is represented by terminating the dividing cell at the moment of division. At division, two daughter cell chains begin. Chains may be two dimensional or multi-dimensional.

With reference to FIG. 7, in one embodiment STroodle 406 provide temporal capabilities to traditional GIS objects. Preferably, STroodle 406 builds on the ToodlePip GIS library (“ToodlePip”) 700 avilable from the assignee of the present invention, BioMedware. ToodlePip 700 provides comprehensive methods for creating and manipulating spatial objects and constructing queries on sets of these objects. The relationship between ToodlePip 700 and STroodle objects 702 is shown in FIG. 7.

ToodlePip 700 offers traditional GIS functions such as object management, persistence, computational geometry, proximity relationships, distance between objects, and reprojection. The ancestral ToodlePip classes, SpatialObject 704 and Pt 706 set the basic methods for derived classes 708. SpatialObject 704 contains general GIS methods for customization within each of the derived classes 708, such as PolygonObject 708, MultiLine 710, and PointObject 712. These general methods include distance, length, overlap, reprojection, copying, as well as data saving and retrieval functions. Pt 706 consists of (x,y) coordinates and methods for working with points, including operators and distance functions. Polygons in ToodlePip and STroodle must be simple polygons, i.e. those that do not overlap themselves.

Derived classes 708 within ToodlePip 700 draw on both SpatialObject 704 and Pt 706. All these classes 708 are types of spatial objects 704, and all classes are made up of point vertices. Thus, the vertices of a PolygonObject 710 or a MultiLine 712, and the coordinates of a PointObject 714 are all individual points and can be manipulated with methods in Pt 706. Within each derived class 708 are methods specific to each type of object, for instance polygons have area while points and lines do not, plus customizations of general SpatialObject methods.

STroodle classes 702 build on existing ToodlePip classes 700. STroodle 406 uses polygons, lines, and points, but adds the temporal dimension to them. Thus, STroodle objects 702 derive not only from ToodlePip objects 700, but also from a new class of object, TimeSpaceObjects 716. The new STroodle object classes 702 have a “T” at the beginning of their names to signify the temporal dimension and distinguish them from ToodlePip objects 700. Thus, TPolygonObject 718 is a STroodle polygon, descendent from both the ToodlePip PolygonObject 710 and the STroodle TimeSpaceObject 716. This inheritance provides STroodle objects 702 with all the functionality of ToodlePip objects 700, plus temporal methods. The characteristics of TimeSpaceObjects are described below.

An object or item may be represented as a time-space object 716 with the following characteristics. Optional fields are listed within parentheses. A complete set of objects composes the object chain that represents the individual's movement through time.

Start Location the location of the entity at the Start Time

Spatial Extent defines the shape of the object at the first observation.

Movement Vector defines the distance and direction moved between the Start and Stop Times. For an object that changes shape during the observation interval, movement vectors describe the trajectory of each vertex of the object.

Start Time the beginning of the time interval when the observation occurred

(Stop Time) the end of the observation interval, optional because some observations are for timepoints rather than intervals

Next Object Pointer and Prior Object Pointer identify to the next and prior TimeSpaceObjects in the chain

Parent Chain identifies the object chain to which the object belongs

Object chains are linked lists of TimeSpaceObjects 716. Aside from position and shape for each object, object chains have additional characteristics, like the attributes such as name, diagnosis, etc. Object chains have the following characteristics:

Start Time the start time of the first object in the chain

End Time the end time of the last object in the chain

First Object and Last Object point to the first and last objects in the chain

Attributes the vector of characteristics of the object and their duration

chain attributes are invariant over the duration of the chain

object attributes can change states during the chain lifetime, but they cannot have a duration shorter than individual subobjects in the chain

Alongside the classes that add time information to existing ToodlePip geometry objects, additional classes were required for STroodle 406. These new classes provide the methods for working with object chains and apply general STroodle methods to public health applications.

Class Chain creates and works with object chains. Object chains consist of a linked list of individual objects. Chain uses the first object in the chain as the pointer to the whole chain, and it holds the vector of object attributes and their duration. This method controls the size of the data files—instead of repeating the list of attributes for each subsequent object in the chain, the list is held in one place.

In the preferred embodiment, Class TRTree creates and works with Hilbert R-trees to index the data (see below).

The STIS class serves as an interface between Chain and TRTree. Working with object chains is the foundation of Space-Time Information Systems, hence the acronym STIS. STIS includes functions to save and read data files and queries that evaluate multiple chains.

For public health applications, STroodle includes class Epidemiology, derived from STIS. Methods in epidemiology allow the user to define an epidemiological event or diagnosis, such as exposure or infection. Then, the event can be tracked through space and time, to find the waiting time between events, the distance between events adjacent in time, and the epidemic curve, or the proportion of susceptible people infected over time. This class applies general methods developed in STIS to epidemiological applications; it exemplifies how programmers can modify existing STroodle classes for their own purposes.

Geographic files contain an immense amount of information. GIS organize this information in spatial databases. To increase search efficiency, GIS index this information. For example, a search for nearest neighbors of a point is simpler if the data is stored as a linked list of nearest neighbors. Indexing allows the program to prune the query space by searching only some of the records in the database. Current GIS programs offer spatial indexing only. STroodle 406 was created to provide spatio-temporal indexing. In one embodiment, STroodle 406 uses a 3-dimensional Hilbert R-Tree to provide spatio-temporal indexing. Other commonly used data structures may alternatively be used, such as, the quadtree, kD-tree, R-tree, and R⁺-tree. The quadtree and the kD-tree are most appropriate for point data. The R-tree structure (originally proposed by Guttman 1984) can handle more complex objects like lines and polygons. The Hilbert R-tree is a variant of the conventional R-tree. While the R-tree uses minimum bounding rectangles to index queries, the Hilbert R-tree uses a fractal, the Hilbert space-filling curve for indexing. This fractal structure makes the Hilbert R-tree up to 28% better than conventional R-trees and quadtrees in terms of storage required and access time. The Hilbert curve can be constructed for 2, 3 or more dimensions. This efficiency and flexibility makes it especially suitable for spatio-temporal indexing.

STroodle 406 allows users to refine data queries with filters. Filters can take a variety of forms. All standard mathematical functions and comparisons can be used in the expression (arithmetic operators, sin, cos, log, etc.). There are two types of filters: targeted and nontargeted functions. Both return type Boolean, which allows the filtering of objects that do not meet the specified condition. Nontargeted filter functions evaluate each object in the initial query, while targeted functions evaluate objects in relationship to a specified target. At the level of ActiveX Controls, filters must be specified as a text expression. C++ programmers have additional options, as described below.

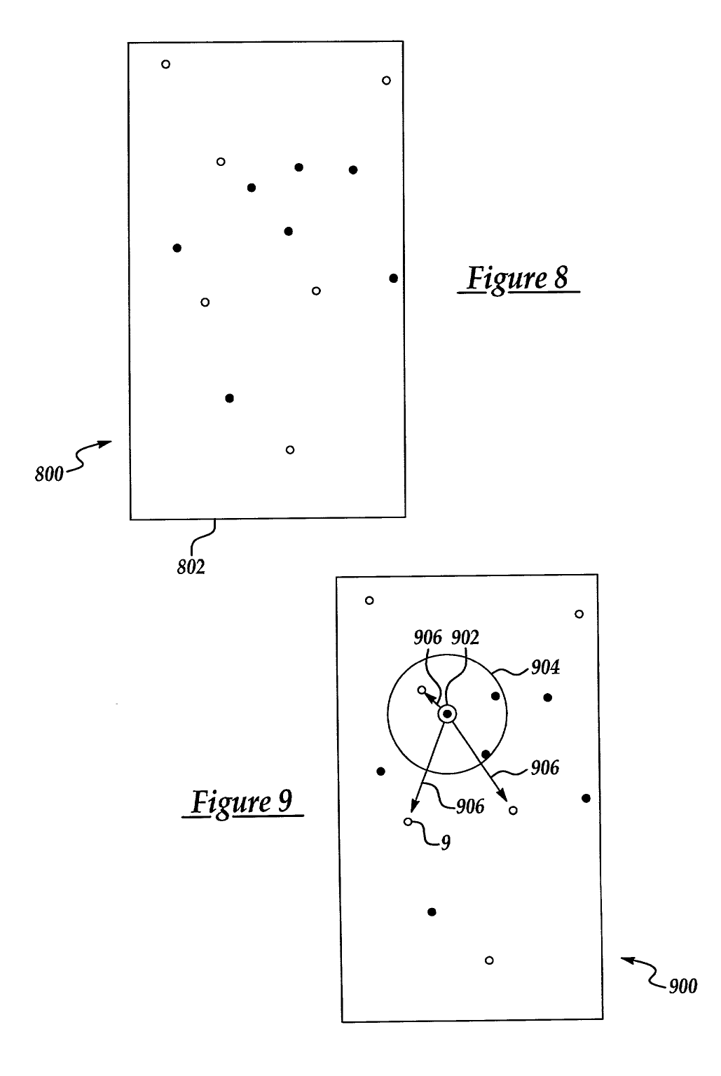

With reference to FIG. 8, an unfiltered rectangular query 800 would return all objects within the rectangle 802, as shown. Such filters could be invoked to return only one type of object, such as infected people, represented as gray dots.

With reference to FIG. 9 a targeted query using a filter 900 is illustrated. In the illustrated example, an unfiltered nearest neighbor query would return the three closest objects to the target 902 contained in the circular buffer 904. Alternatively, the exemplary filter 900 would return only objects with attributes that differ from the target. For example, one might want to find the closest objects with a different disease status than the target, i.e. susceptible if the target is infected and infective if the target is susceptible. The solid arrows 906 point to the three nearest objects with a different diagnosis.

Filters are user-defined expressions that restrict queries and customize other STroodle methods. In addition to the mathematical expressions listed in the table below, filters can take object expressions. To specify object expressions, the following syntax must be used. One can use the keywords previous and next to evaluate the previous and next subobjects and the keyword attribute (taking a single integral parameter) to return a character string attribute. Finally isfirst and islast are Boolean functions which return true (1) if the subobject is the first or last subobject in the chain respectively.

| syntax | true if . . . |
|---|---|
| not object.previous.attribute(5)=“k” | attribute(5) of the previous |
| | object is not “k” |
| object.previous.attribute(5)!=“k” | attribute(5) of the previous |
| | object is not “k” |
| object.previous.attribute(5)=“s” | attribute(5) of the previous |
| | object is “s” |
| object.next.attribute(3)=“e” | attribute(3) of the next |
| | object is “e” |
| object.attribute(1)=“r” | attribute(1) of the previous |
| | object is “r” |
| object.isfirst | object is the first in the chain |
| object.islast | object is the last in the chain |

Text expressions are written in this syntax as illustrated in the examples below.

nontargeted filters

object.attribute(2)==“infected” and (object.isfirst or object.previous.attribute(2) !=“infected”)

This expression returns true if a subobject is the first in its chain to be infected, (or is infected and is the first subobject in the chain). As a filter this expression would filter out all objects except those just infected.

SUBSTR(object.attribute(1), “Nurse”)

Returns true if the object's first attribute contains the word “Nurse”.

targeted filters

target. attribute(1) !=neighbor.attribute(1)

Returns true if the target object's first attribute differs from the neighbor object's first attribute.

Available mathematical functions

| code | arguments | description |
|---|---|---|
| + | 2 | plus |
| − | 2 | minus |
| * | 2 | multiplication |
| | 2 | multiplication (nothing need |
| | | be specified) |
| / | 2 | division |
| abs | 1 | absolute value |
| acos | 1 | arccosine |
| asin | 1 | arcsine |
| atan | 1 | arctangent |
| atan | 1 | arc hyperbolic tangent |
| h | | |
| cos | 1 | cosine |
| cosh | 1 | hyperbolic cosine |
| exp | 1 | exponent (e^{x}) |
| log | 1 | natural log (ln) |
| log1 | 1 | log (base 10) |
| 0 | | |
| mod | 2 | modulus or remainder |
| | | function (x mod y) |
| pow | 2 | power (x^{y}) |
| sin | 1 | sine |
| sinh | 1 | hyperbolic sine |
| sqrt | 1 | squareroot |
| tan | 1 | tangent |
| tanh | 1 | hyperbolic tangent |
| max | 2 | maximum, returns maximum |
| | | of two arguments |
| min | 2 | minimum, returns minimum |
| | | of two arguments |
| subs | 2 | true if second string |
| tr | | argument occurs anywhere |
| | | in the first |

B. C++ filters

STroodle 406 provides two ways to create filters for C++ queries: formula objects and FilterFunctions. The class formula has a single constructor that takes a C string holding a filter expression. This expression is the same form as the text expression described above. FilterFunctions are hard-coded C++ functions. Because they are not hard-coded, formulas can be defined in real time but execute more slowly.

Most of the query functions in STroodle take as parameters both a pointer to a FilterFunction and a pointer to a formula object. Only one of the two should be specified in a given query. If not specified, these parameters have a default value of NULL.

Filter functions come in two forms—the nontargeted FilterFunction or the targeted FilterFunction2. These functions compare chain or object attributes. As FilterFunction evaluates the attributes of one object, it takes one pointer. FilterFunction2 compares two objects, and it takes a pointer for the target and the neighbor. Because attributes can come in three formats, double, long, and character string, STroodle defines several attribute structures. attributeTag is a struct that contains the requested attribute, e.g. attribute(1), in the following format: struct attributeTag {double d; long 1; string s;}.

An individual attribute contains only one format, so only one of the three types will be defined. This method allows for general filter functions to be written that do not require a specific attribute type.

Other important attribute-related structures are attributeSpan and attribute. attributeSpan returns the duration of a particular attribute. This quantity is undefined for chain attributes, which are invariant over time.

struct attributeSpan

{
TimeSpaceObject *startObject, *endObject;
double GetStartTime();
double GetlEndTime();
};

attribute contains two vectors, the attribute states and the duration of each.

struct attribute

{
enum attTypeTag {chain, object} attType;
enum dataTypeTag {doubleType, longType, stringType} dataType;
vector<attributeTag> states;
vector<attributeSpan> intervals;
};

C++ nontargeted filter example 1

Here a filter function is defined that determines whether an object has just been infected. This function finds the part of a chain where a patient first becomes infected by comparing the states (whether Attribute(2)=“infected”) of adjacent objects in the object chain representing the patient. For objects without prior objects, i.e. the first object in a chain, the function returns true if infected. It can be defined as a FilterFunction

bool justInfected(const TimeSpaceObject *obj)

```
{
attributeTag tag = obj−>GetAttribute(2);
if (tag.s != “infected”) return false;  // attribute 2 is a string so use “.s”
const TimeSpaceObject *prevObj = obj−>GetPreviousObject();
if (prevObj)
  {
  attributeTag tag2 = prevObj−>GetAttribute(2);
  // if previous object's attribute isn't “infected” the current one's the first
  return (tag2.s != “infected”);
}
  return true; // first subobject in chain is infected
}
```

or as a formula

formula justInfectedForm(“object. attribute(2)==\“infected\” and \ (object.isfirst or object.previous.attribute(2) !=\“infected\”)”, formula::nontargeted);

Once it is defined, the filter can be passed to a query function. For example, to add a filter to the query function FindNearestObject, declared as

FindNearestObject(double x, double y, double t, formula *form=NULL, FilterFunction func=NULL),

a filter to find the nearest just-infected objects could be specified in one of two ways

FindNearestObject(double x, double y, double t, NULL, justInfected)

OR

FindNearestObject(double x, double y, double t, justInfectedForm)

C++ nontargeted filter example 2

Below is a filter function defined that determines whether an object chain is a nurse. This function searches within the first attribute (holding the chain's name) for any occurrence of the substring “Nurse”.

It can be defined as a FilterFunction:

bool nurseFilter(const TimeSpaceObject *obj)

{
attributeTag tag = obj−>GetAttribute(0);
string name = tag.s;
// find returns the position of “Nurse” or the end position if not found:
return (name.find(“Nurse”) < name.size());
}

or as a formula:

formula onlyNurses(“SUBSTR(object. attribute(1), \“Nurse\”)”, formula::nontargeted);

Once it is defined, the filter can be used within a query. For FindNearestObject, declared above:

FindNearestObject(double x, double y, double t, NULL, nurseFilter)

OR

FindNearestObject(double x, double y, double t, *onlynurses)

Unfiltered, FindNearestObject returns the object nearest to a set of spatio-temporal coordinates (x,y,t). When filtered in this way, it returns the nearest nurse.

C++ targeted filter example

The following example defines a targeted filter that returns true if two compared objects have different health states, in this case the value in the Attribute(1) field. It could be achieved using a FilterFunction2:

bool differentStates(const TimeSpaceObject *obj 1, const TimeSpaceObject

*obj2)

{
attributeTag tag = obj1−>GetAttribute(1);
attributeTag tag2 = obj2−>GetAttribute(1);
return tag.s != tag2.s; // attribute 1 is a string
}

or a formula:

formula diffStates(“target.attribute(1) !=neighbor.attribute(1)”, formula::targeted),

Once defined, it could be specified in a query taking FilterFunction2, such as one that returns the minimum distance between two objects:

FindNearestToObject(Chain *obj, double t, formula *form=NULL, FilterFunction2 func=NULL)

can be specified as

FindNearestToObject(Chain *obj, double t, NULL, differentStates)

OR

FindNearestToObject(Chain *obj, double t, *diffstates)

Unfiltered, FindNearestToObject returns the nearest object to the specified chain at time t. Filtered as above, the object returned is the nearest object with a different first attribute.

D. Queries

1. Data Management

Initialize WM_QRY_INITIALIZE

description: initializes the internal data structures input: none

returns: nothing

Read File WM_QRY_READFILE

description: read a disk file of time-space objects

input: name of file

returns: nothing

Finish WM_QRY_FINISH

description: destroy the internal data structures

input: none

returns: nothing

Bounds WM_QRY_BOUNDS

description: gets the bounds of the data set.

input: none.

returns: xmin, xmax, ymin, ymax, start time, end time (6 doubles).

2. Identify chains, objects, and attributes

All Objects WM_QRY_OTHER_ALLOBJECTS

description: gets the ids of all the objects.

input: nontargeted filter: char string

returns: object Ids: longs

Sub-Object in Chain WM_QRY OTHER_SUBOBJECTINCHAIN

description: finds the sub-object in an object chain which exists at a specified time

input: object Id: 1 long

time: 1 double

returns: sub-object Id: 1 long

Object Chain from Sub-Object WM_QRY_OTHER_CHAINFROMSUBOBJECT

description: finds the object chain containing the specified sub-object

input: sub-object Id: 1 long

returns: object chain Id: 1 long

Preceding Sub-Object WM—QRY_OTHER_PRECEDINGSUBOBJECT

description: returns the sub-object preceding the specified sub-object in time

input: sub-object Id: 1 long

returns: sub-object Id: 1 long

note: an Id of 0 is returned if there is no preceding sub-object.

Following Sub-Object WM_QRY_OTHER_FOLLOWINGSUBOBJECT

description: returns the sub-object following the specified sub-object in time

input: sub-object Id: 1 long

returns: sub-object Id: 1 long

note: an Id of 0 is returned if there is no following sub-object.

Sub-Object Attribute WM_QRY_OTHER_SUBOBJECTATTRIBUTE

description: retrieves the value of the specified attribute of a sub-object

input: id of the object: 1 long

attribute index: 1 long

returns: attribute: character string

Sub-Object Lifespan WM_QRY_OTHER_SUBOBJECTLIFESPAN

description: returns the time interval when a sub-object is in existence

input: sub-object Id: 1 long

returns: time interval, [t1,t2]: 1 pair of doubles

3. Spatial Queries

Nearest Neighbor to Point WM_QRY_SPACE_NEIGHBORPOINT

description: finds the nearest neighbors to a point at a specified time

input: query point, (x,y): 2 doubles

query time: 1 double

number of neighbors: 1 long

nontargeted filter: char string (defined p. 16)

returns: neighbor Id's: longs

array of distances to neighbors: doubles

Nearest Neighbor to Object WM_QRY_SPACE_NEIGHBOROBJECT

description: finds the nearest neighbors to a specified object at a specified time

input: object Id: long

query time: 1 double

number of neighbors: 1 long

targeted filter: char string

returns: neighbor Ids: longs

array of distances to neighbors: doubles

Adjacency WM_QRY_SPACE_ADJACENCY

description: finds all objects within a threshold distance of a specified object during a time interval

input: object Id: long

threshold distance: double

time interval, [t1,t2]: 2 doubles

targeted filter: char string

returns: object Id's of nearby objects: long

Border Polygons WM—QRY_SPACE_BORDERPOLYGONS

description: finds all polygons bordering the specified polygon at a specified time

input: object Id: long

time: 1 double

targeted filter: char string

returns: object Id's of bordering polygons: longs

Distance WM_QRY_SPACE_DISTANCE

description: finds the distance between two objects at time t

input: Id of first object: 1 long

Id of second object: 1 long

time: 1 double

returns: distance: double

notes: Objects can be points, multilines, or polygons. A distance of −1 is returned if either object doesn't exist at time t.

Common Polygon Border WM_QRY_SPACE_COMMONPOLYGONBORDER

description: finds the length of shared border between two polygons at time t

input: object Id of first polygon: 1 long

object Id of second polygon: 1 long

time: 1 double

returns: length of common border: 1 double

notes: Zero is returned if the polygons share no border.

Length WM_QRY_SPACE_LENGTH

description: calculates the length of a multiline or polygon at time t

input: object Id: long

time: double

returns: length: double

note: The length of a point is zero.

Polygon Containment WM_QRY_SPACE_POLYGONCONTAINMENT

description: finds those objects wholly contained by a polygon at time t

input: number of polygon vertices: 1 long

polygon vertices: pairs of doubles

query time: 1 double

nontargeted filter: char string

returns: object Id's of contained polygons

note: The polygon must be simple, i.e. one that does not overlap itself

Polygon Overlap WM_QRY_SPACE_POLYGONOVERLAP

description: finds those objects overlapping a polygon at time t

input: number of polygon vertices: 1 long

polygon vertices: pairs of doubles

query time: 1 double

nontargeted filter: char string

returns: object Id's of overlapped objects

note: The polygon must be simple, i.e. one that does not overlap itself

Rectangle Overlap WM_QRY_SPACE_RECTANGLEOVERLAP

description: finds those objects overlapping a rectangle at time t

input: rectangle bounds (xmin, ymin, xmax, ymax): 4 doubles

query time: 1 double

nontargeted filter: char string

returns: object Id's of overlapped objects

Circle Overlap WM_QRY_SPACE_CIRCLEOVERLAP

description: finds those objects overlapping a circle at time t

input: circle center: 2 doubles

circle radius: 1 double

query time: 1 double

nontargeted filter: char string

returns: object Id's of overlapped objects

Object Overlap WM_QRY_SPACE_OBJECTOVERLAP

description: finds those objects overlapping a specified object at time t

input: object Id of query object: 1 long

query time: 1 double

targeted filter: char string

returns: object Id's of overlapped objects

Polygon Area WM_QRY_SPACE_POLYGONAREA

description: calculates the area of a polygon object.

input: object Id of polygon: 1 long

returns: area: 1 double

note: The polygon must be simple, i.e. one that does not overlap itself

Point Path WM_QRY_SPACE_POINTPATH

description: converts a point moving in time to a set of vertices. This method tracks the movement through time and collapses the time information

input: object Id of the point: 1 long

time interval: 2 doubles.

returns: number of vertices: 1 long

vertices: pairs of doubles

Position at Time WM_QRY_SPACE_POSITIONATTIME

description: gets the vertices of an object at a specified time

input: object Id of query object: 1 long

query time: 1 double

returns: vertices: array of pairs of doubles

All Positions at Time WM_QRY_SPACE_ALLPOSITIONSATTIME

description: gets the vertices of all objects at a specified time

input: query time: 1 double

attribute index: 1 long

returns: number of objects: long

object Ids: longs

attribute: char string

vertices: array of pairs of doubles

Position through Time WM_QRY_SPACE_POSITIONTHROUGHTIME

description: gets the vertices of a moving object during a specified time interval

input: object Id of query object: 1 long

time interval, [t1,t2]: 2 doubles

returns: number of intervals between t1 and t2: long

for each interval: start time, t1: double

number of vertices at t1: long

vertices (x,y) at t1: pairs of doubles

end time, t2: double

number of vertices at t2: long

vertices (x,y) at t2: pairs of doubles

4. Network Queries

Nearest Network Neighbors WM_QRY_NETWORK_NEARESTNEIGHBOR

description: gets the vertices of an object at a specified time

input: object Id of query object: 1 long

query time: 1 double

returns: vertices: array of pairs of doubles

description: finds the nearest neighbors to a specified node on the network

input: object Id of the point: 1 long

number of neighbors: long

returns: number of neighbors: 1 long

array of object Id's: long

Adjacent Network Neighbors WM_QRY_NETWORK_ADJACENTNEIGHBORS

description: finds the nodes immediately adjacent to the specified node

input: object Id of the query node: 1 long

returns: number of adjacent objects, 1 long

array of object Id's: long

Network Distance WM_QRY NETWORK_DISTANCE

description: calculates the distance between two nodes on the network

input: object Id of the first node: 1 long

object Id of the second node: 1 long

returns: length of shortest connecting route along network: 1 double

number of nodes between specified nodes: 1 long

Network Neighbors by Distance WM_QRY_NETWORK_NEIGHBORSBYDISTANCE

description: finds those nodes within a specified distance of a target node

input: object Id: 1 long

distance: 1 double

returns: number of neighboring objects, 1 long

array of object Id's: long

Network Neighbors by Node WM_QRY_NETWORK_NEIGHBORSBYNODE

description: finds those neighbors which are separated by a certain number of nodes from a specified target object.

input: object Id: 1 long

node separation: 1 long

returns: number of neighboring objects, 1 long

array of object Id's: long

5. Temporal Queries

Time Slice WM_QRY_TIME_SLICE

description: finds all objects that exist at a specified time

input: time: double

returns: array of object Id's: long

Interval Containment WM_QRY_TIME_INTERVALCONTAINMENT

description: finds all objects whose lifespan is wholly contained within a specified time interval

input: time interval, [t1, t2]: 2 doubles

nontargeted filter: char string

returns: array of object Id's: long

Interval Overlap WM_QRY_TIME_INTERVALOVERLAP

description: finds all objects whose occur within a specified time interval

input: time interval, [t1, t2]: 2 doubles

nontargeted filter: char string

returns: array of object Id's: long

Lifespan Intersection WM_QRY_TIME_LIFESPANINTERSECTION

description: finds the intersection of the lifespans of two specified object chains

input: object Id's of the two objects: 2 longs

returns: array of time intervals, [t1,t2]: pairs of doubles

Lifespan Union WM_QRY_TIME_LIFESPANUNION

description: finds the union of the lifespans of two specified objects

input: object Id's of the two objects: 2 longs

returns: array of time intervals, [t1,t2]: pairs of doubles

Object Attributes WM_QRY_TIME_OBJECTATTRIBUTES

description: retrieves the values of the specified attribute of an object over a specified interval

input: id of the object: 1 long

attribute index: 1 long

time interval, [t1, t2]: 2 doubles

returns: number of attribute states in [t1, t2]: long for each state:

attribute: character string

attribute state interval, [t1, t2]: 2 doubles

Attribute at Time WM_QRY_TIME_ATTRIBUTEATTIME

description: retrieves the value of the specified attribute of an object at a specified time

input: id of the object: 1 long

attribute index: 1 long

time: 1 double

returns: character string

Object Lifespan WM_QRY_TIME_OBJECTLIFESPAN

description: returns the time intervals when an object is in existence

input: object Id: 1 long

returns: array of time intervals, [t1,t2]: pairs of doubles

6. Spatio-temporal Queries

Inside Threshold Distance WM_QRY_SPACETIME_INSIDETHRESHOLDDISTANCE

description: finds the time intervals within a specified interval when two objects are within a specified distance

input: object id's of the two objects: long

time interval, [t1, t2]: 2 doubles

threshold distance: 1 double

returns: array of time intervals, [t1,t2]: pairs of doubles

Outside Threshold Distance WM_QRY_SPACETIME_OUTSIDETHRESHOLDDISTANCE

description: finds the time intervals within a specified interval when two objects are separated by a distance greater than a specified distance

input: object id's of the two objects: long

time interval, [t1, t2]: 2 doubles

threshold distance: 1 double

returns: array of time intervals, [t1,t2]: pairs of doubles

Polygon Containment Intervals WM—QRY_SPACETIME_POLYGONCONTAINMENTINTERVALS

description: finds the time intervals within a given interval when the specified object is wholly contained by a specified polygon

input: id of the object: long

time interval, [t1, t2]: 2 doubles

vertices of the polygon: pairs of doubles

returns: array of time intervals, [t1,t2]: pairs of doubles

note: The polygon must be simple, i.e. one that does not overlap itself

Distance over Time WM_QRY_SPACETIME_DISTANCEOVERTIME

description: finds the distance between two objects during a time interval

input: id's of the two objects: 2 longs

time interval, [t1, t2]: 2 doubles

time resolution: 1 double

returns: distance array: doubles

Minimum Distance WM_QRY_SPACETIME_MINIMUMDISTANCE

description: finds when, in a specified interval, two objects are at their minimum distance

input: id's of the two objects: 2 longs

time interval, [t1, t2]: 2 doubles

returns: minimum time: double

minimum distance: double

Collision WM_QRY_SPACETIME_COLLISION

description: finds when, in a specified interval, two objects intersect.

input: id's of the two objects: 2 longs

time interval, [t1, t2]: 2 doubles

returns: array of time intervals, [t1,t2]: pairs of doubles

All Object Collisions WM_QRY_SPACETIME_ALLCHAINCOLLISIONS

description: finds all objects intersected by a specified object chain in a specified interval

input: id of the object chain: 1 long

time interval, [t1, t2]: 2 doubles

targeted filter: char string

returns: array of object ids: longs

All Collisions WM_QRY_SPACETIME_ALLCOLLISIONS

description: finds all object collisions occurring in a specified interval

input: time interval, [t1, t2]: 2 doubles

nontargeted filter: char string

returns: array of object-id pairs: longs

Brushes with Object WM_QRY_SPACETIME_BRUSHES

description: finds all objects passing within a threshold distance of a target in a specified interval.

input: id of the object: 1 long

time interval, [t1, t2]: 2 doubles

threshold distance: 1 double

targeted filter: char string

returns: array of object ids: longs

7. Epidemiological Queries

Define Event WM_QRY_EPI_DEFINEEVENT

description: allows the user to define an event using a filter, intended for diagnoses and other epidemiological applications. This method then creates a chronological list of the events and the objects associated with them for subsequent queries

input: object ids: longs

nontargeted filter: char string

returns: nothing.

First Event WM_QRY_EPI_FIRSTEVENT

description: finds the first event

input: none.

returns: Id of the event's sub-object: long

Interval Events WM_QRY_EPI_INTERVALEVENTS

description: finds all events occurring in a specified time interval.

input: time interval, [t1, t2]: double

nontargeted filter: char string

returns: array of sub-object id's: longs

Nearest Events in Time WM_QRY EPI_NEARESTEVENTS

description: finds the k nearest events around a specified focus event

input: sub-object id of the focus event: long

maximum number of events to return: long

search direction: long

returns: up to k sub-object id's: long

note: Set search direction code to −1 to search only for events before focus event. Set it to 0 to search for nearest events before and after focus event, and to 1 to search only after the focus event.

Nearest Events to Time WM_QRY_EPI_NEARESTEVENTSTOTIME

description: finds the k nearest events around a specified time

input: time: double

maximum number of events to return: long

search direction: long

returns: up to k sub-object id's: long

note: Set search direction code to −1 to search only for events before focus event. Set it to 0 to search for nearest events before and after focus event, and to 1 to search only after the focus event.

Waiting Time WM_QRY_EPI_WAITINGTIME

description: finds the time between two events

input: sub-object id of the first event: long

sub-object id of the second event: long

returns: waiting time: double

Adjacent Waiting Times WM_QRY EPI_ADJACENTWAITINGTIMES

description: calculates the waiting times between events adjacent in time

input: time interval, [t1, t2]: double

returns: waiting times: doubles

Adjacent Waiting Time/Distance Pairs M_QRY_EPI_ADJACENTWTDISTANCEPAIRS

description: calculates the waiting times between events adjacent in time and the associated distances between the objects

input: time interval, [t1, t2]: double

returns: waiting time/distance pairs: array of pairs of doubles

All Waiting Time/Distance Pairs WM_QRY_EPI_ALLWTDISTANCEPAIRS

description: calculates the waiting times between all pair-wise combinations of events, and the associated distances between the objects

input: time interval, [t1, t2]: double

returns: waiting time/distance pairs: array of pairs of doubles

Find Exposed Objects WM_QRY_EPI_FINDEXPOSED

description: returns the objects which spent more than a specified amount of time within a specified threshold distance of a target object during a time interval.

input: target Id: 1 long

threshold distance: 1 double

threshold time period: 1 double

time interval, [t1,t2]: 2 doubles

targeted filter: char string

returns: object Ids: longs

Exposure Time WM_QRY_EPI_EXPOSURETIME

description: returns the cumulative amount of time the target object spent within a threshold distance of other objects during a time interval

input: target Id: 1 long

threshold distance: 1 double

time interval, [t1,t2]: 2 doubles

targeted filter: char string

returns: total time: 1 double

Epidemic Curve WM_QRY_EPI_EPIDEMICCURVE

description: calculates the epidemic curve based on the current diagnosis for a specified time interval. The y-axis describes the incidence rate, the number of disease events divided by the susceptible person-time. Generally, an approximation is used, the proportion of susceptible people infected. This approximation counts people infected during the interval as infected for the numerator and susceptible for the entire denominator. With the temporal information in STroodle data, we can calculate the actual incidence rate, dividing the number of events by the susceptible person time in the interval. The x-axis divides the specified time interval equally into the number of bins described

input: number of bins: 1 long

time interval, [t1,t2]: 2 doubles

returns: incidence rates: doubles

E. C++ Classes and Functions

As described above, STroodle 406 builds on classes created in ToodlePip. List below are the STroodle implementation of object classes, such as TimeSpaceObject, TPointObject, and TPolygonObject. In many cases, methods in derived classes override methods in their ancestral class; when this occurs, the methods will be listed for derived classes, but only described in the ancestral class. For example, the function GetBoundingRegion is only described in TimeSpaceObject, though it can be called within other derived classes. To get the bounding region of a TPolygon object, refer to the definition of GetBoundingRegion under TimeSpaceObject.

Functions within classes will be organized in loose groups, e.g. Get-type commands together, Set-type commands together, followed by more complex queries. The name of the command will be followed by the format of the command, with the return type ahead of the command and parentheses surrounding the input parameters required to execute the function. The parameters, if any, will be described, followed by a general description of the function itself. Groups of functions will have a title when the group begins. Following pages will have the group title at the top right of the page in the header for ease of reference.

1. Class TimeSpaceObject

constructors

no public constructors

virtual ˜TimeSpaceObject( )

takes no parameters

description: TimeSpaceObject destructor

public methods

CreateObjectAtTime

virtual TimeSpaceObject* CreateObjectAtTime(double t)

parameters: double t-time

description: copies this at time t. Essentially, this function creates a new object that is a snapshot of this at time t, containing the position information and setting the start and end time to t

Get Functions

GetStartTime

double GetStartTime( )

takes no parameters

description: returns the start time of a time space object

GetEndTime

double GetEndTime( )

takes no parameters

description: returns the stop time of a time space object

GetLifeSpan

double GetLifeSpan( )

takes no parameters

description: returns difference between the object's start and end times

GetMovement

const list<Pt> & GetMovement( )

takes no parameters

description: returns the movement vector during the observation interval as a list of x, y coordinates representing the displacement of each coordinate during the observation

GetNextObject

TimeSpaceObject*GetNextObject( )

const TimeSpaceObject*GetNextObject( )

takes no parameters

description: two methods which return a pointer to the next object in the object chain

GetPreviousObject

TimeSpaceObject* GetPreviousObject( )

const TimeSpaceObject*GetPreviousObject( )

takes no parameters

description: two methods which return a pointer to the previous object in the object chain

GetParentChain

Chain* GetParentChain( )

takes no parameters

description: returns a pointer to the object's parent chain

GetAttribute

attributeTag GetAttribute(int index)

parameters: int index—the category within which to look

attributeTag—a struct containing the attribute state, defined p. 20.

description: looks within the parent chain for the attribute of this

GetVertexCount

virtual long GetVertexCount( )

takes no parameters

description: returns the number of vertices of subobject

GetVertices

virtual list<Pt> GetVertices( )

takes no parameters

description: returns a list of the x, y coordinates of the vertices of the subobject

GetObjectType

virtual long GetObjectType( )

takes no parameters

description: returns the object type of the subobject (point, line, polygon)

GetBoundingRegion

virtual NRect GetBoundingRegion(double t)

parameters: double t—the time for which the bounding rectangle is required

description: gets minimum bounding rectangle for this at time t. This method uses CreateObjectAtTime to take a snapshot of this to find the bounding region.

GetMaxBoundingRegion

virtual NRect GetMaxBoundingRegion( )

takes no parameters

description: finds the bounding rectangle for the object between the start and end times. This command will return the same rectangle as GetBoundingRegion unless the object moves during the observation interval.

Set Functions

SetStartTime

Void SetStartTime(double t)

parameters: double t—the new end time

description: sets start of observation interval

SetEndTime

void SetEndTime(double t)

parameters: double t—the new end time

description: sets end of observation interval

SetMovement

void SetMovement(const list<Pt>&)

parameters: const list<Pt>&—pointer to the list of displacements for each coordinate

description: sets the movement vectors for observation interval

SetParentChain

void SetParentChain(Chain *ch)

parameters: Chain *ch—pointer to parent chain

description: sets which chain the object belongs within

SetNextObject

void SetNextObject(TimeSpaceObject *)

parameters: TimeSpaceObject *—object pointer

description: designates specified object as subsequent to this

SetPreviousObject

void SetPreviousObject(TimeSpaceObject *)

parameters: TimeSpaceObject *—object pointer

description: designates specified object as previous to this

Length and Distance

LengthAtTime

virtual double LengthAtTime(double t)

parameters: double t—time

description: returns the object length at the specified time

Distance

virtual double Distance(const TimeSpaceObject &obj)

parameters: const TimeSpaceObject &obj—object pointer

description: calculates distance between object and this at beginning of observation interval

NRectDistance

virtual double NRectDistance(doubleList &mins, doubleList &maxs)

parameters: doubleList &mins—coordinates of rectangle minimum

doubleList &maxs-coordinates of rectangle maximum

description: calculates the nearest distance between object and an N-Rectangle. This method includes choosing the closest point of N-Rect from which to measure the distance.

example: the lines represent the nearest distance between the N-Rect and the grey points.

DistanceAtTime

virtual double DistanceAtTime(TimeSpaceObject &obj, double t)

parameters: TimeSpaceObject &obj—object pointer

double t—time to calculate distance

description: calculates the distance between two objects at a specified time within the observation interval

DistanceOverTime

virtual double DistanceOverTime(const TimeSpaceObject &obj, double t1, double t2, double dt, double *distances)

parameters: const TimeSpaceObject &obj—object pointer

double t1—start time of observation interval

double t2—end time of interval

double dt—-resolution of distance over time calculation

double *distances—pointer to list of distances at each timepoint

description: calculates the distance between two objects during a time interval, saves a distance array of doubles

MinimumDistance

virtual double MinimumDistance(const TimeSpaceObject &obj, double t1, double t2, double &time)

parameters: const TimeSpaceObject &obj—object pointer

double t1—interval start time

double t2—interval end time

double &time—pointer to the vector of ??

description: calculates when, in a specified time interval, two objects are at their minimum distance

TimeInsideDistance

virtual timeList TimeInsideDistance(const TimeSpaceObject &obj, double t1, double t2, double threshold)

parameters: const TimeSpaceObject &obj—object pointer

double t1—start time of observation interval

double t2—end time of interval

double dt—resolution of distance over time calculation

double threshold—threshold distance

description: finds the times within a specified time interval when objects are within a specified threshold distance

TimeOutsideDistance

virtual timeList TimeOutsideDistance(const TimeSpaceObject &obj, double t1, double t2, double threshold)

parameters: const TimeSpaceObject &obj—object pointer

double t1—start time of observation interval

double t2—end time of interval

double dt—resolution of distance over time calculation

double threshold—threshold distance

description: finds the times within a specified interval when objects are outside a specified distance

Overlap

OverlapsObjectAtTime

virtual bool OverlapsObjectAtTime(const TimeSpaceObject &, double t)

parameters: const TimeSpaceObject&-object pointer

double t—time

description: returns Boolean whether objects overlap in space during a specified time interval

OverlapsRectAtTime

virtual bool OverlapsRectAtTime(const Rect &r, double t)

parameters: const Rect &r—rectangle pointer

double t—time

description: returns Boolean whether object overlaps rectangle

OverlapsCircleAtTime

virtual bool OverlapsCircleAtTime(const Pt &p, double radius, double t)

parameters: const Pt &p—pointer to center of circle, a point

double radius—the circle's radius

double t—time

description: returns Boolean whether object overlaps circle of specified radius

OverlapsPolyAtTime

virtual bool OverlapsPolyAtTime(const BasicPolygon &r, double t)

parameters: const BasicPolygon &r—pointer to polygon

double t—time

description: returns Boolean whether object overlaps specified polygon. The polygon must be simple, i.e. one that does not overlap itself

OverlapsInTime

bool OverlapsInTime(const TimeSpaceObject &obj)

parameters: const TimeSpaceObject &obr—pointer to object

description: returns Boolean (Y/N) whether objects ever exist at the same time

Containment & Intersection

ContainedByPolyAtTime

virtual bool ContainedByPolyAtTime(const BasicPolygon &r, double t)

parameters: const BasicPolygon &r—pointer to polygon

double t—time

description: returns Boolean whether object is contained within polygon at specified time. The basic polygon must be simple, i.e. one that does not overlap itself

ContainedByPoly

virtual bool ContainedByPoly(const BasicPolygon &r, double t1, double t2, timeList &times)

parameters: const BasicPolygon &r—pointer to polygon

double t1—start time of observation

double t2—end time of observation

timeList &times—pointer to list of times of containment

description: returns Boolean whether object is contained by polygon during the interval between specified times. The basic polygon must be simple, i.e. one that does not overlap itself

Intersects

virtual bool Intersects(const TimeSpaceObject &obj, double t1, double t2, timeList &times)

parameters: const TimeSpaceObject &obj—pointer to object

double t1—start time of observation

double t2—end time of observation

timeList &times—pointer to list of times of intersection

description: returns Boolean whether two objects intersect at any point between the specified times Class TPointObject

1. class TPointObject: public PointObject, public TimeSpaceObject

constructors

TPointObject( )

takes no parameters

description: default constructor

TPointObject(const TPointObject &)

parameters: const TPointObject &—pointer to object

description: copy constructor, copies existing TPointObject

TPointObject(const TPointObject &, double t)

parameters: const TPointObject &—pointer to object

double t—snap shot time

description: copies another point at the specified time, the new object has a start and end time equal to the specified time (like CreateNewObject)

TPointObject(const PointObject&, double t1, double t2)

parameters: const PointObject &—pointer to object

double t1—start time

double t2—end time

description: adds time information to a ToodlePip PointObject, specify start and end time

TPointObject(double t1, double t2)

parameters: double t1—start time

double t2—end time

description: creates new object with start and end times, you then must add other characteristics with set commands

TPointObject(double x, double y, double t1, double t2)

parameters: double x—X coordinate of object

double y—Y coordinate of object

double t1—start time

double t2—end time

description: creates a new TPointObject, setting the (x, y) coordinates and the start and end times

virtual ˜TPointObject( )

takes no parameters

description: TPointObject destructor

3. class TMultiLine: public MultiLine, public TimeSpaceObject

constructors

TMultiLine( )

takes no parameters

description: default constructor

TMultiLine(const TMultiLine &);

parameters: const TMultiLine &—pointer to object

description: copy constructor, copies existing TMultiLine

TMultiLine(const TMultiLine &, double t);

parameters: const TPointObject &—pointer to object

double t—snapshot time

description: copies another line at the specified time, the new object has a start and end time equal to the specified time (like CreateNewObject)

TMultiLine(const MultiLine &, double t1, double t2);

parameters: const MultiLine &—pointer to object

double t1—start time

double t2—end time

description: adds time information to a ToodlePip MultiLine, specify start and end time

TMultiLine(double t1, double t2)

parameters: double t1—start time

double t2—end time

description: creates new object with start and end times, you then must add other characteristics with set commands

virtual ˜TMultiLine( )

takes no parameters

description: TMultiLine destructor

4. class TPolygonObject: public PolygonObject, public TimeSpaceObject

STroodle polygons must be simple, that is they do not overlap themselves.

constructors

TPolygonObject( )

takes no parameters

description: default constructor

TPolygonObject(const TPolygonObject &p)

parameters: const TPolygonObject &p—pointer to object

description: copy constructor, copies existing TPolygonObject

TPolygonObject(const TPolygonObject &p, double t)

parameters: const TPolygonObject &p—pointer to object

double t—snapshot time

description: copies another TPolygonObject at the specified time, the new object has a start and end time equal to the specified time (like CreateNewObject)

TPolygonObject(const BasicPolygon &p, double t1, double t2);

parameters: const BasicPolygon &p—pointer to object

double t1—start time

double t2—end time

description: adds time information to a ToodlePip BasicPolygon, specify start and end time

TPolygonObject(const PolygonObject &p, double t1, double t2);

parameters: const PolygonObject &—pointer to object

double t1—start time

double t2—end time

description: adds time information to a ToodlePip PolygonObject, specify start and end time

TPolygonObject(double t1, double t2)

parameters: double t1—start time

double t2—end time

description: creates new object with start and end times, you then must add other characteristics with set commands

virtual ˜TPolygonObject( );

takes no parameters

description: TPolygonObject destructor

5. Class Chain

constructors

Chain(class TimeSpaceObject *first)

parameters: TimeSpaceObject *first—pointer to the first object in the chain

description: creates a chain using the first object, the subsequent members of the chain can be found by following links within each object

Chain(fstream &f)

parameters: fstream &f—pointer fstream location

description: creates a chain from the fstream

virtual Chain( )

takes no parameters

description: Chain destructor, also deletes all objects in chain

6. Data Saving and Access Functions

SaveToDisk

void SaveToDisk (fstream &file)

parameters: fstream &file—location of file into which to save

description: save disk file of TimeSpaceObject chains

ReadFromDisk string ReadFromDisk(fstream &file)

parameters: fstream &file—location of file into which to save

description: read from a disk file of TimeSpaceObject chains

7. Get Functions

GetChain

TimeSpaceObject* GetChain( )

takes no parameters

description: returns pointer to first object in chain

GetFirstObject

const TimeSpaceObject* GetFirstObject( )

TimeSpaceObject* GetFirstObject( )

takes no parameters

description: two methods that return a pointer to the first object in chain

GetLastObject

const TimeSpaceObject* GetLastObject( )

TimeSpaceObject* GetLastObject( )

takes no parameters

description: two methods that return a pointer to the last object in chain

GetAttributeCount

int GetAttributeCount( )

takes no parameters

description: gets the number of attribute fields

GetAttribute

attribute & GetAttribute(int i)

bool GetAttribute(int index, attributeTag &tag, double t=0)

parameters: attribute &—a struct which contains 2 vectors, one of attribute states and one with the duration of each attribute, defined on p. 20

int i, int index—the attribute category

attributeTag &tag—pointer to location where attribute state returned as an attributeTag, defined p. 20

double t—time to return attribute, default time specified to zero, as some attributes are invariant over the duration of the chain

description: returns the ith attribute for a chain at a

GetBoundingRegion

NRect GetBoundingRegion( )

takes no parameters

description: finds the bounding rectangle for the chain between its start and end times

GetSubObject

TimeSpaceObject* GetSubObject(double t)

const TimeSpaceObject* GetSubObject(double t)

parameters: double t—time

description: two methods that return a pointer to the object in the chain that exists at the specified time

GetStartTime

double GetStartTime( )

takes no parameters

description: returns the start time of the first time space object in the chain

GetEndTime

double GetEndTime( )

takes no parameters

description: returns the stop time of a the last time space object in the chain

GetLength

int GetLength( )

int GetLength(TimeSpaceObject *start, TimeSpaceObject *end)

parameters: TimeSpaceObject* start—the pointer to the first time space object TimeSpaceObject* end—the pointer to the last time space object

description: two methods that return timespans. The first takes no parameters and returns the chain lifespan, the difference between the start time of the first object and the end time of the last object. The second calculates the length between two objects in the chain, not necessarily the first and last.

8. Attribute Functions

AttributesThroughTime

strings AttributesThroughTime(int, double t1, double t2, timeList &)

parameters: int i—attribute field

double t1—start of time interval

double t1—end of time interval

timeList &—pointer to list of times

description: returns list of attributes of object chain at observations within time interval with the time intervals each attribute exists

SetAttribute

bool SetAttribute(int i, TimeSpaceObject *obj, double datum)

bool SetAttribute(int i, TimeSpaceObject *obj, long datum)

bool SetAttribute(int i, TimeSpaceObject *obj, const char *datum)

parameters: int i—attribute field

TimeSpaceObject *obj—object pointer

double datum—attribute in double format

long datum—attribute in long format

const char *datum—attribute in char format

description: three methods to assign ith attribute to an object in a chain, a method for each type of attribute

NewChainAttribute

void NewChainAttribute(double datum)

void NewChainAttribute(long datum)

void NewChainAttribute(const char *datum)

parameters: double datum—attribute in double format

long datum—attribute in long format

const char *datum—attribute in char format

description: three methods to create a new column in the vector of attributes for a chain, a method for each type of attribute. The attribute is set to the specified value for the entire chain. See FIG. 4.1

NewObjectAttribute

void NewObjectAttribute(TimeSpaceObject *obj, double datum)

void NewObjectAttribute(TimeSpaceObject *obj, long datum)

void NewObjectAttribute(TimeSpaceObject *obj, const char *datum)

parameters: TimeSpaceObject *obj—object pointer

double datum—attribute in double format

long datum—attribute in long format

const char *datum—attribute in char format

description: three methods to create a new attribute column for an object, a method for each type of attribute. The attribute is set to the specified value for the duration of the object. See FIG. 4.1

AppendObjectAttribute

void AppendObjectAttribute(int i, TimeSpaceObject *obj, double datum)

void AppendObjectAttribute(int i, TimeSpaceObject *obj, long datum)

void AppendObjectAttribute(int i, TimeSpaceObject *obj, const char *datum)

parameters: int i—attribute field

TimeSpaceObject *obj—object pointer

double datum—attribute in double format

long datum—attribute in long format

const char *datum—attribute in char format

description: three methods to add a new state to the list of attribute states or a new time period to an existing state. See FIG. 4.1 to distinguish AppendObjectAttribute from NewChainAttribute and NewObjectAttribute.

9. Chain Functions

Append

void Append(TimeSpaceObject *)

parameters: TimeSpaceObject *obj—object pointer

description: splices object to this. May splice two object chains together if the appended TimeSpaceObject points to subsequent objects.

ExtendChain

TimeSpaceObject* ExtendChain( )

takes no parameters

description: extends the chain by creating a new object from the last object in the chain. It duplicates the attributes and sets the start and end times equal to the end time of the duplicated object.

10. Distance and Proximity

Distances

void Distances(Chain &obj, double t1, double t2, double dt, double *)

parameters: Chain &obj—chain pointer

double t1—interval start time

double t2—interval end time

double dt—timestep resolution

double *—pointer of to list of times and distances

description: creates vector of distances between this and specified chain within time interval

MinimumDistance

double MinimumDistance(Chain &, double t1, double t2, double &, formula *form=NULL, FilterFunction2 func=NULL)

parameters: Chain &—chain pointer

double t1—interval start time

double t2—interval end time

double &—pointer to the vector of ??

formula* form=NULL—filter function, default not specified

FilterFunction2 func=NULL—targeted filter function, default not specified

description: calculates when, in a specified time interval, this is at its minimum distance from the specified chain

ClosestSubObject

TimeSpaceObject* ClosestSubObject(double t)

parameters: double t—time

description: finds closest subobject to this at time t

11. Time Lists and Snapshots

PointPathThroughTime

MultiLine* PointPathThroughTime(double t1, double t2)

parameters: double t1—start time

double t2—end time

description: returns point path through time during the specified interval as a set of vertices for a multiline. This method retains the sequence of positions retained, but the time information is lost

TimeSliceObject

TimeSpaceObject* TimeSliceObject(double t)

parameters: double t—snapshot time

description: creates a new object that is a duplicate of the object in the chain which exists at time t. This new object has start and end times equal to t.

ExistsAtTime

bool ExistsAtTime(double t)

parameters: double t—time

description: returns Boolean whether this has a subobject that exists at time t

ExistenceTimes

timeList ExistenceTimes(double t1, double t2)

parameters: double t1—start time

double t2—end time

description: returns timelist when this exists within time interval

FilterFunctionTimes

timeList FilterFunctionTimes(formula *form=NULL, FilterFunction

func=NULL)

parameters: formula*form =NULL—filter function, default not specified

FilterFunction2 func=NULL—targeted filter function, default not specified

description: returns timelist when this has attributes that satisfy the filter function

CollisionTimes

void CollisionTimes(Chain &, double t1, double t2, timeList &, formula

*form=NULL, FilterFunction2 func=NULL)

parameters: Chain &—chain pointer

double t1—interval start time

double t2—interval end time

timelist &—pointer to timelist

formula*form NULL—filter function, default not specified

FilterFunction2 func=NULL—targeted filter function, default not specified

description: creates a list of the time intervals when this collides with the specified chain, can be further restricted to when this and the chain have specific attributes

WithinThresholdTimes

void WithinThresholdTimes(Chain &, double t1, double t2, double threshold, timeList &, formula *form=NULL, FilterFunction2 func=NULL)

parameters: Chain &—chain pointer

double t1—interval start time

double t2—interval end time

double threshold—threshold distance

timelist &—pointer to timelist

formula*form=NULL—filter function, default not specified

FilterFunction2 func=NULL—targeted filter function, default not specified

description: creates a list of the time intervals when this is within a threshold distance of the specified chain, can be further restricted to when this and the chain have specific attributes

PolygonContainmentTimes

void PolygonContainmentTimes(BasicPolygon &, double t1, double t2, timeList &)

parameters: BasicPolygon &—polygon pointer

double t1—interval start time

double t2—interval end time

timelist &—pointer to timelist

description: creates a list of the time intervals when this is within the specified polygon. The basic polygon must be simple, i.e. one that does not overlap itself

12. Class STIS

constructors

STIS( )

takes no parameters

description: default constructor

STIS(fstream &)

parameters: fstream &—pointer to fstream location

description: create STIS object from memory

virtual ˜STIS( )

takes no parameters

description: STIS object destructor

public methods

Data and Chain Functions

SaveToDisk(fstream &file)

bool SaveToDisk(fstream &file) const;

parameters: fstream &file—location of file into which to save

description: save disk file of TimeSpaceObject chains

ReadFromDisk

bool ReadFromDisk(fstream &file);

parameters: fstream &file—location of file into which to save

description: read from a disk file of TimeSpaceObject chains

AddChain(Chain *chain)

virtual void AddChain(Chain *chain),

parameters: Chain*chain—pointer to the chain

description: add a chain to the internal data structure

RemoveChain

virtual void RemoveChain(Chain *chain)

parameters: Chain*chain—pointer to the chain

description: removes chain from internal data structure, does not delete the chain from memory

BuildRTree

void BuildRTree( )

takes no parameters

description: build Hilbert R-tree to index data for faster searching

Get Functions

GetChainByIndex

Chain* GetChainByIndex(long index)

parameters: long index—attribute in index field

description: returns the chain pointer after inputting chain name

GetChainCount

long GetChainCount( )

takes no parameters

description: returns the total # of chains in internal data structure

GetBoundingRect

NRect GetBoundingRect( )

takes no parameters

description: gets the bounding rectangle for all objects in internal data structure

GetChainList

ChainVector & GetChainList( )

takes no parameters

description: lists all chains in internal data structure

Proximity

FindNearestObject

TimeSpaceObject* FindNearestObject(double x, double y, double t, formula *form=NULL, FilterFunction func=NULL)

parameters: double x—X coordinate of location

double y—Y coordinate of location

double t—timepoint for search

formula*form=NULL—filter function, default not specified

FilterFunction func=NULL—filter function, default not specified

description: find the nearest object to an (x, y) position at time t. Filter functions are described in Chapter 2.

FindNextNearest

TimeSpaceObject* FindNextNearest(formula *form=NULL, FilterFunction func=NULL)

parameters: formula*form=NULL—filter function, default not specified

FilterFunction func=NULL—filter function, default not specified

description: find the next nearest object

FindNearestToObject

TimeSpaceObject* FindNearestToObject(Chain *obj, double t, formula *form=NULL, FilterFunction2 func=NULL)

parameters: Chain *obj—chain pointer

double t—timepoint for search

formula*form=NULL—filter function, default not specified

FilterFunction2 func=NULL—targeted filter function, default not specified

description: find nearest object to this at time t

FindNextToObject

TimeSpaceObject* FindNextToObject(formula *form=NULL, FilterFunction2 func=NULL)

parameters: formula*form=NULL—filter function, default not specified

FilterFunction2 func=NULL—targeted filter function, default not specified

description: find next nearest object

BorderingPolygons

TSOList BorderingPolygons(TimeSpaceObject *obj, double t, formula *form=NULL, FilterFunction2 func=NULL)

parameters: TimeSpaceObject *obj—object pointer

double t—timepoint for search

formula*form=NULL—filter function, default not specified

FilterFunction2 func=NULL—targeted filter function, default not specified

description: returns all objects bordering specified object at time t

Containment and Overlap

RectQuery

TSOList RectQuery(Rect r, double t, formula *form=NULL, FilterFunction func=NULL)

parameters: Rect r—struct taking 4 doubles (xmin, ymin, xmax, ymax)

xmin—minimum×coordinate for rectangle

ymin—minimum y coordinate for rectangle

xmax—maximum×coordinate for rectangle

ymax—maximum y coordinate for rectangle

double t—timepoint for search

formula*form=NULL—filter function, default not specified

FilterFunction func=NULL—filter function, default not specified

description: returns list of objects within rectangle r

CircleQuery

TSOList CircleQuery(double x, double y, double r, double t, formula *form=NULL, FilterFunction func=NULL)

parameters: double x—X coordinate of circle center

double y—Y coordinate of circle center

double r—radius of circle

double t—timepoint for search

formula*form=NULL—filter function, default not specified

FilterFunction func=NULL—filter function, default not specified

description: returns list of objects within the circle at time t

PolygonContainmentQuery

TSOList PolygonContainmentQuery(const BasicPolygon &poly, double t, formula *form=NULL, FilterFunction func=NULL)

parameters: const BasicPolygon &poly—polygon pointer

double t—timepoint for search

formula*form=NULL—filter function, default not specified

FilterFunction func=NULL—filter function, default not specified

description: lists TimeSpaceObjects contained within polygon at time t. The basic polygon must be simple, i.e. one that does not overlap itself

PolygonOverlapQuery

TSOList PolygonOverlapQuery(const BasicPolygon &poly, double t, formula *form=NULL, FilterFunction func=NULL)

parameters: const BasicPolygon & poly—polygon pointer

double t—timepoint for search

formula*form=NULL—filter function, default not specified

FilterFunction func=NULL—filter function, default not specified

description: lists TimeSpaceObjects that intersect or that are contained within the polygon at time t. The basic polygon must be simple, i.e. one that does not overlap itself

Attribute and Time Queries

AttributeQuery

TSOList AttributeQuery(formula *form=NULL, FilterFunction func=NULL)

parameters: formula*form=NULL—filter function, default not specified

FilterFunction func=NULL—filter function, default not specified

description: lists all objects meeting the specified attributes

TimeIntervalQuery

TSOList TimeIntervalQuery(double t1, double t2, formula *form=NULL, FilterFunction func=NULL)

parameters: double t1—time interval start

double t2—time interval end

formula*form=NULL—filter function, default not specified

FilterFunction func NULL—filter function, default not specified

description: lists all objects existing within time interval

Collisions

ObjectCollisions

TSOList ObjectCollisions(TimeSpaceObject *obj, double t1, double t2, formula *form=NULL, FilterFunction2 func=NULL)

parameters: TimeSpaceObject *obj—object pointer

double t1—search start time

double t2—search end time

formula*form=NULL—filter function, default not specified

FilterFunction2 func=NULL—targeted filter function, default not specified

description: lists objects that collide with specified TimeSpaceObject during time interval

ChainCollisions

ChainList ChainCollisions(Chain *chain, double t1, double t2, formula *form=NULL, FilterFunction2 func=NULL)

parameters: Chain *chain—chain pointer

double t1—search start time

double t2—search end time

formula*form NULL—filter function, default not specified

FilterFunction2 func=NULL—targeted filter function, default not specified

description: lists chains that collide with specified chain during specified time interval

AllCollisions

ChainList AllCollisions(double t1, double t2, formula *form=NULL, FilterFunction2 func=NULL)

parameters: double t1—search start time

double t2—search end time

formula*form=NULL—filter function, default not specified

FilterFunction2 func=NULL—targeted filter function, default not specified

description: lists all collisions that occur within the time interval

Close Calls

CloseCalls

ChainList CloseCalls(Chain *chain, double t1, double t2, double threshold, formula *form=NULL, FilterFunction2 func=NULL)

parameters: Chain *chain—chain pointer

double t1—search start time

double t2—search end time

double threshold—threshold distance

formula*form=NULL—filter function, default not specified

FilterFunction2 func=NULL—targeted filter function, default not specified

description: lists objects that come within threshold distance of specified chain within time interval

CloseCallsToObject

TSOList CloseCallsToObject(TimeSpaceObject *obj, double t1, double t2, double threshold, formula *form=NULL, FilterFunction2 func=NULL)

parameters: TimeSpaceObject *obj—object pointer

double t1—search start time

double t2—search end time

double threshold—threshold distance

formula*form=NULL—filter function, default not specified

FilterFunction2 func=NULL—targeted filter function, default not specified

description: lists objects that have close calls with TimeSpaceObject within specified time interval, called by CloseCallsClass Epidemiology

13. public STIS

enum eventDir {previousEvts, followingEvts, aroundEvts}

parameters: previousEvts—specifies the n events previous to the focal event

followingEvts—specifies the n events following the focal event

aroundEvts—specifies the n events closest in time to the focal event, regardless of position before or after the event

description: an integral variable used within Epidemiology for queries. It is used for specifying which of the three possible ways of identifying nearest events is requested

constructors

Epidemiology( )

takes no parameters

description: default constructor

Epidemiology(fstream &f)

parameters: fstream &f—pointer to fstream location

description: creates Epidemiology object from memory

virtual ˜Epidemiology( )

takes no parameters

description: Epidemiology object destructor

public methods

ConstructDiagnosisList

void ConstructDiagnosisList(const ChainVector &, formula *str)

void ConstructDiagnosisList(const ChainVector &, FilterFunction func)

parameters: const ChainVector &—pointer to the ? formula *str—filter function FilterFunction func—filter function

description: two methods for constructing a chronological list of patients with a specific diagnosis (specified by a formula or a filter function)

FindExposed

ChainList FindExposed(Chain *Mary, double t1, double t2, double threshold, double contactDuration, formula *form=NULL, FilterFunction2 func=NULL)

parameters: Chain*Mary—pointer to infective chain

double t1—search start time

double t2—search end time

double threshold—threshold distance for exposure

double contactDuration—minimum time of contact for exposure

formula*form=NULL—filter function, default not specified

FilterFunction2 func=NULL—targeted filter function, default not specified

description: finds all chains exposed to infective individual within specified time interval

NearestDiagnoses

TSOList NearestDiagnoses(double t, int count, eventDir dir)

parameters: double t—time to search

int count—the number of objects to return

eventDir dir—the type of nearest objects (see enum at beginning of class Epidemiology)

description: list diagnoses nearest in time

Get functions

GetDiagnosisCount

long GetDiagnosisCount( )

takes no parameters

description: returns count of chains with a particular diagnosis

GetFirstDiagnosis

TimeSpaceObject* GetFirstDiagnosis( )

takes no parameters

description: returns first diagnosis on diagnosis list, diagnosis list is arranged chronologically

GetDiagnoses

TSOList GetDiagnoses(double t1, double t2, formula *form=NULL, FilterFunction func=NULL);

parameters: double t1—search start time

double t2—search end time

formula*form=NULL—filter function, default not specified

FilterFunction func=NULL—filter function, default not specified

description: returns all diagnoses within time interval

GetExposureTime

double GetExposureTime(Chain *Mary, double t1, double t2, double threshold, formula *form=NULL, FilterFunction2 func=NULL)

parameters: Chain*Mary—pointer to infective chain

double t1—search start time

double t2—search end time

double threshold—threshold distance for exposure

formula*form=NULL—filter function, default not specified

FilterFunction2 func=NULL—targeted filter function, default not specified

description: returns the cumulative time of exposure between an individual chain and all other objects within time interval (can be filtered to return only chains with different diagnosis from target chain)

GetAdjacentWaitingTimes

list<double> GetAdjacentWaitingTimes(double t1, double t2)

parameters: double t1—search start time

double t2—search end time

description: Once the diagnosis list has been constructed

(ConstructDiagnosisList), waiting times between health events can be found. The next three methods return waiting times in different formats. GetAdjacentWaitingTimes returns the waiting times between events adjacent on the diagnosis list.

GetAdjacentDistanceWTPairs

list<double> GetAdjacentDistanceWTPairs(double t1, double t2)

parameters: double t1—search start time

double t2—search end time

description: lists waiting times and the distances between events adjacent on the diagnosis list in the specified time interval

GetAllDistanceWTPairs

list<double> GetAllDistanceWTPairs(double t1, double t2)

parameters: double t1—search start time

double t2—search end time

description: lists the distances and waiting times between all events on the diagnosis list within the specified time interval. This method is different from GetAdjacentDistanceWTPairs because it lists every possible pairwise combination of events on the diagnosis list (comparing event 1 with events 2-10, event 2 with 1 and 3-10, etc.)

GetEpidemicCurveData

void GetEpidemicCurveData(double t1, double t2, int bins, vector<double>&)

parameters: double t1—search start time

double t2—search end time

int bins—the number of divisions, or the resolution, on time axis

vector<double> &—vector of bar heights for histogram

description: gets data required to draw an epidemic curve based on the current diagnosis for a specified time interval. The y-axis describes the incidence rate, the number of disease events divided by the susceptible person-time. Generally, an approximation is used, the proportion of susceptible people infected. This approximation counts people infected during the interval as infected for the numerator and susceptible for the entire denominator. With the temporal information in STroodle data, we can calculate the actual incidence rate, dividing the number of events by the susceptible person time in the interval. The x-axis divides the specified time interval equally into the number of bins specified.

14. Class TRTree

constructors

TRTree( )

takes no parameters

description: default constructor

TRTree(NRect bounds)

parameters: NRect—ToodlePip object, a rectangle with an unchanging position over time does it have a specified time interval?

description: makes a Hilbert R-tree of all objects and chains within the NRect

˜TRTree( )

takes no parameters

description: TRTree destructor

public methods

Get Functions

GetSize

long GetSize( )

takes no parameters

description: returns the number of objects in the Hilbert R-tree

GetAllChains

ChainList GetAllChains( )

takes no parameters

description: gets the list of all chains in Hilbert R-tree

GetAllObjects

TSOList GetAllObjects(formula *form=NULL, FilterFunction func=NULL)

parameters: formula*form=NULL—filter function, default not specified

FilterFunction func=NULL—filter function, default not specified

description: gets all objects in chain, can be filtered

GetAllObjectsAtTime

TSOList GetAllObjectsAtTime(double t, formula *form=NULL, FilterFunction func=NULL)

parameters: double t—time

formula*form=NULL—filter function, default not specified

FilterFunction func=NULL—filter function, default not specified

description: finds all objects in Hilbert R-tree at time t, can be filtered

Proximity

BorderingPolygons

TSOList BorderingPolygons(TimeSpaceObject *obj, double t, formula *form=NULL, FilterFunction2 func=NULL)

parameters: TimeSpaceObject *obj—object pointer

double t—timepoint of search

formula*form=NULL—filter function, default not specified

FilterFunction2 func=NULL—targeted filter function, default not specified

description: finds all polygons bordering specified object at time, can be filtered

FindFirstNearest

TimeSpaceObject* FindFirstNearest(double x, double y, double t, formula *form=NULL, FilterFunction func=NULL)

parameters: double x—X coordinate

double y—Y coordinate

double t—timepoint

formula* form NULL—filter function, default not specified

FilterFunction func=NULL—filter function, default not specified

description: finds nearest object to 2 specified time—space coordinates

FindNext

TimeSpaceobject* FindNext(formula *form=NULL, FilterFunction func=NULL)

parameters: formula*form=NULL—filter function, default not specified

FilterFunction func=NULL—filter function, default not specified

description: finds next nearest object

FindFirstNearestToObject

TimeSpaceObject* FindFirstNearestToObject(Chain *obj, double t, formula *form=NULL, FilterFunction2 func=NULL)

parameters: Chain *obj—chain pointer

double t—timepoint

formula*form=NULL—filter function, default not specified

FilterFunction2 func=NULL—targeted filter function, default not specified

description: finds nearest object to specified chain at time t, can be filtered

FindNextToObject

TimeSpaceObject* FindNextToObject(formula *form=NULL, FilterFunction2 func=NULL)

parameters: formula*form NULL—filter function, default not specified

FilterFunction2 func=NULL—targeted filter function, default not specified

description: finds next nearest object to specified chain at time t, can be filtered

Containment and Overlap RectQuery

TSOList RectQuery(Rect r, double t, formula *form=NULL, FilterFunction func=NULL)

parameters: Rect r—struct taking 4 doubles (xmin, ymin, xmax, ymax)

xmin—minimum x coordinate for rectangle

ymin—minimum y coordinate for rectangle

xmax—maximum x coordinate for rectangle

ymax—maximum y coordinate for rectangle

double t—timepoint for search

formula*form NULL—filter function, default not specified

FilterFunction func=NULL—filter function, default not specified

description: returns list of objects within rectangle r

CircleQuery

TSOList CircleQuery(double x, double y, double r, double t, formula *form—NULL, FilterFunction func=NULL)

parameters: double x—X coordinate of circle center

double y—Y coordinate of circle center

double r—radius of circle

double t—timepoint for search

formula*form=NULL—filter function, default not specified

FilterFunction func=NULL—filter function, default not specified

description: returns list of objects within the specified circle at time t

PolygonOverlapQuery

TSOList PolygonOverlapQuery(const BasicPolygon &poly, double t, formula *form=NULL, FilterFunction func=NULL)

parameters: const BasicPolygon &poly—polygon pointer

double t—timepoint for search

formula*form NULL—filter function, default not specified

FilterFunction func=NULL—filter function, default not specified

description: lists TimeSpaceObjects that intersect or that are contained within the polygon at time t. The basic polygon must be simple, i.e. one that does not overlap itself

PolygonContainmentQuery

TSOList PolygonContainmentQuery(const BasicPolygon &poly, double t, formula *form=NULL, FilterFunction func=NULL)

parameters: BasicPolygon &—polygon pointer

double t—timepoint

formula*form=NULL—filter function, default not specified

FilterFunction func=NULL—filter function, default not specified

description: creates a list objects contained within the polygon at time t. The basic polygon must be simple, i.e. one that does not overlap itself

TimeIntervalQuery

TSOList TimeIntervalQuery(double t1, double t2, formula *form=NULL, FilterFunction func=NULL)

parameters: double t1—time interval start

double t2—time interval end

formula*form NULL—filter function, default not specified

FilterFunction func=NULL—filter function, default not specified

description: lists all objects existing within time intervalCollisions

ChainCollisions

ChainList ChainCollisions(Chain *obj, double t1, double t2, formula *form=NULL, FilterFunction2 func=NULL)

parameters: Chain *obj—chain pointer

double t1—beginning of time interval

double t2—end of time interval

formula*form=NULL—filter function, default not specified

FilterFunction2 func=NULL—targeted filter function, default not specified

description: returns list of all chains that collide with specified chain during the time interval

ObjectCollisions

TSOList ObjectCollisions(TimeSpaceObject *obj, double t1, double t2, formula *form=NULL, FilterFunction2 func=NULL)

parameters: TimeSpaceObject *obj—object pointer

double t1—beginning of time interval

double t2—end of time interval

formula*form=NULL—filter function, default not specified

FilterFunction2 func=NULL—targeted filter function, default not specified

description: returns list of all objects that collide with specified object during the time interval

AllCollisions

ChainList AllCollisions(double t1, double t2, formula *form=NULL, FilterFunction func=NULL)

parameters: double t1—beginning of time interval

double t2—end of time interval

formula*form=NULL—filter function, default not specified

FilterFunction func=NULL—filter function, default not specified

description: returns list of all chains that collide during the time interval

Close Calls

CloseCalls

ChainList CloseCalls(Chain *obj, double t1, double t2, double threshold, formula *form=NULL, FilterFunction2 func=NULL)

parameters: Chain *obj—chain pointer

double t1—beginning of time interval

double t2—end of time interval

double threshold—maximum distance to qualify as a close-call

formula*form=NULL—filter function, default not specified

FilterFunction2 func=NULL—targeted filter function, default not specified

description: returns list of all chains that come within specified distance of specified chain during the time period

CloseCallsToObject

TSOList CloseCallsToObject(TimeSpaceObject *obj, double t1, double t2, double threshold, formula *form=NULL, FilterFunction2 func=NULL)

parameters: TimeSpaceObject *obj—object pointer

double t1—beginning of time interval

double t2—end of time interval

double threshold—maximum distance to qualify as a close-call

formula*form=NULL—filter function, default not specified

FilterFunction2 func NULL—targeted filter function, default not specified

description: returns list of all objects that come within specified distance of specified object during the time period

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. An object oriented data model for modeling an item using a computer, comprising:
a data parameter; and,
a time parameter, wherein an instance of the object oriented data model has a data value associated with the data parameter and a time value associated with the time parameter, the data value being associated with the instance of the item at the time value.

2. An object oriented data model, as set forth in claim 1, wherein the time value is a discrete value.

3. An object oriented data model, as set forth in claim 1, wherein the time value is a range of time with a start value and an end value.

4. An object oriented data model, as set forth in claim 1, wherein the item is a biological organism.

5. An object oriented data model, as set forth in claim 1, wherein the item is a geometric construct.

6. An object oriented data model, as set forth in claim 5, wherein the construct is a point.

7. An object oriented data model, as set forth in claim 5, wherein the construct is a line.

8. An object oriented data model, as set forth in claim 5, wherein the construct is a multi-line.

9. An object oriented data model, as set forth in claim 5, wherein the construct is a polygon.

10. An object oriented data model, as set forth in claim 5, wherein the construct is a circle.

11. A programming tool for modeling an object that moves through time, comprising:
an object oriented data model including a data parameter and a time parameter, wherein an instance of the object oriented data model has a data value associated with the data parameter and a time value associated with the time parameter, the data value being associated with the instance of the item at the time value;
a chain of instances of the object oriented data model, the plurality of instances of the object oriented data model representing the object as the object moves through time; and,
a plurality of methods adapted to operate on the chain of instances of the object oriented data model.

12. A programming tool, as set forth in claim 11, wherein the time value is a discrete value.

13. A programming tool, as set forth in claim 11, wherein the time value is a range of time with a start value and an end value.

14. A programming tool, as set forth in claim 11, wherein the item is a biological organism.

15. A programming tool, as set forth in claim 11, wherein the item is a geometric construct.

16. A programming tool, as set forth in claim 15, wherein the construct is a point.

17. A programming tool, as set forth in claim 15, wherein the construct is a line.

18. A programming tool, as set forth in claim 15, wherein the construct is a multi-line.

19. A programming tool, as set forth in claim 15, wherein the construct is a polygon.

20. A programming tool, as set forth in claim 15, wherein the construct is a circle.

21. A programming tool, as set forth in claim 11, wherein the plurality of methods includes spatial queries.

22. A programming tool, as set forth in claim 21, wherein the spatial queries includes at least one of a length query, area query, position query, point path query, nearest neighbor query, adjacency query, border polygons query, border length query, distance query, overlap query, and polygon containment query.

23. A programming tool, as set forth in claim 11, wherein the plurality of methods includes network queries.

24. A programming tool, as set forth in claim 24, wherein the network queries includes at least one of a distance query, adjacency query, nearest neighbor query, and neighbors by node query.

25. A programming tool, as set forth in claim 11, wherein the plurality of methods includes spatial-temporal object queries.

26. A programming tool, as set forth in claim 25, wherein the spatial-temporal object queries includes at least one of an object chain and subject query, a threshold distance query, a minimum distance query, a polygon containment interval query, a distance over time query, a collision query, a close call query, and a distance between objects over time query.

27. A programming tool, as set forth in claim 11, wherein the object is an infectious disease.

28. A programming tool, as set forth in claim 11, wherein the object is related to human commerce as occurs in sales, marketing and business.

29. A programming tool, as set forth in claim 11, wherein the object is a pixel in a remotely sensed image.

30. A programming tool, as set forth in claim 27, wherein the plurality of methods includes epidemiological queries.

31. A programming tool, as set forth in claim 30, wherein the plurality of epidemiological queries includes event/diagnosis queries.

32. A programming tool, as set forth in claim 31, wherein the event/diagnosis queries includes at least one of a define event query, a find first event query, a find events in interval query, a nearest events to focus event query, a nearest event to certain time query, a waiting time between pairs of events query, and a waiting time between all events query.

33. A programming tool, as set forth in claim 30, wherein the epidemiological queries includes at least one of an exposure time query, a find exposed query, and an epidemic curve query.

34. A computer based method of modeling items using an object oriented data model with space and time data, including:
representing an item in a first instance of the data model, the data model including at least one data parameter, a value of the data parameter within the first instance of the data model being associated in time with the first instance; and,
representing the item in a second instance of the data model, the value of the data parameter tracking a spatial-time event of the item in the second instance of the data model.

35. A computer based method, as set forth in claim 34, wherein the first and second instances of the data model form a chain.

36. A computer based method, as set forth in claim 34, wherein time data for each instance includes a discrete value.

37. A computer based method, as set forth in claim 34, wherein the time data is a range of time with a start value and an end value.

38. A computer based method, as set forth in claim 34, wherein the item is a biological organism.

39. A computer based method, as set forth in claim 34, wherein the item is related to human commerce as occurs in sales, marketing, and business.

40. A computer based method, as set forth in claim 34, wherein the item is a pixel in a remotely sensed image.

41. A computer based method, as set forth in claim 34, wherein the item is a geometric construct.

42. A computer based method, as set forth in claim 41, wherein the construct is a point.

43. A computer based method, as set forth in claim 41, wherein the construct is a line.

44. A computer based method, as set forth in claim 41, wherein the construct is a multi-line.

45. A computer based method, as set forth in claim 41, wherein the construct is a polygon.

46. A computer based method, as set forth in claim 41, wherein the construct is a circle.

47. A computer based method, as set forth in claim 35, including the step of performing a method on the chain.

48. A computer based method, as set forth in claim 35, including the step of performing a spatial query on the chain.

49. A computer based method, as set forth in claim 47, wherein the spatial query is one of a length query, area query, position query, point path query, nearest neighbor query, adjacency query, border polygons query, border length query, distance query, overlap query, and polygon containment query.

50. A computer based method, as set forth in claim 35, including the step of performing a network query on the chain.

51. A computer based method, as set forth in claim 50, wherein the network query is one of a distance query, adjacency query, nearest neighbor query, and neighbors by node query.

52. A computer based method, as set forth in claim 35, including the step of performing a spatial-temporal object query.

53. A computer based method, as set forth in claim 52, wherein the spatial-temporal object query is one of an object chain and subject query, a threshold distance query, a minimum distance query, a polygon containment interval query, a distance over time query, a collision query, a close call query, and a distance between objects over time query.

54. A computer based method, as set forth in claim 35, wherein the item is an infectious disease.

55. A computer based method, as set forth in claim 54, including the step of performing an epidemiological query on the chain.

56. A computer based method, as set forth in claim 55, wherein the epidemiological query is an event/diagnosis queries.

57. A computer based method, as set forth in claim 56, wherein the event/diagnosis queries is one of a define event query, a find first event query, a find events in interval query, a nearest events to focus event query, a nearest event to certain time query, a waiting time between pairs of events query, and a waiting time between all events query.

58. A computer based method, as set forth in claim 55, wherein the epidemiological query is one of an exposure time query, a find exposed query, and an epidemic curve query.

59. A computer based method, as set forth in claim 35, wherein the item is related to human commerce as occurs in sales, marketing, and business.

60. A computer based method, as set forth in claim 35, wherein the item is a pixel in a remotely sensed image.
